(19) United States
(12) Patent Application Publication
(10) Pub. No.: US 2013/0252317 A1
(43) Pub. Date: Sep. 26, 2013

(54) PROCESS FOR THE ENZYMATIC PURIFICATION OF OILS OF VEGETABLE OR ANIMAL ORIGIN

(71) Applicants: Rudolf Bönsch, Nackenheim (DE); Eckhard Seidel, Frankfurt am Main (DE)

(72) Inventors: Rudolf Bönsch, Nackenheim (DE); Eckhard Seidel, Frankfurt am Main (DE)

(73) Assignee: LURGI GmbH, Frankfurt am Main (DE)

(21) Appl. No.: 13/990,235

(22) PCT Filed: Nov. 4, 2011
(86) PCT No.: PCT/EP2011/005562

§ 371 Date: May 29, 2013

(30) Foreign Application Priority Data
Dec. 18, 2010 (DE) 10 2010 055 159.7

(51) Int. Cl. C11B 3/00

(52) U.S. Cl. CPC C11B 3/003
USPC 435/271

(57) ABSTRACT

A method for the enzymatic breakdown of phosphorus-containing constituents and glycosides, in particular steryl glycoside, from crude oil or pre-degummed oil of vegetable or animal origin, wherein for both cases the addition of the enzymes is effected in one method step.

### FIELD OF THE INVENTION

This invention relates to a method for removing phosphorus-containing constituents and steryl glycosides from crude oil or pre-degummed oil of vegetable or animal origin by using enzymes. Crude oil is understood to be expressed oil and oil extracted from a press cake by means of hexane or ethanol.

### PRIOR ART

Methods for the enzymatic degumming of oils and for the enzymatic breakdown of glycoside in the oil are known.

EP 0 513 709 B2 describes a method for reducing the content of phosphorus- and iron-containing constituents in pre-degummed oil, from which the hydratable phosphatides are removed, by enzymatic breakdown by means of a phospholipase. In this method, an organic carboxylic acid and an enzyme solution, which contains the phospholipases A1, A2 and B, are stirred into the oil by forming an emulsion. The resulting breakdown products of the non-hydratable phosphatides pass over into the water phase and are removed with the same by centrifugation.

The separation of steryl glycosides from the oil is not discussed in this document.

WO 2009/106360 A2 describes a method for separating glycoside, in particular steryl glycoside, by enzymatic breakdown from a biodiesel precursor, biodiesel or mixtures thereof and also from oils and fats, in particular degummed oils and fats with a reduced lecithin content. The enzyme is mixed into the substrate in an aqueous solution. The sugar content of the split steryl glycoside passes over into the aqueous phase and is separated with the same.

The separation of phosphatides from the oil is not discussed in this document. Since each of these method steps, i.e. separation of the phosphatides and separation of the glycosides, performed separately according to the prior art, means a considerable equipment expenditure, it was the object to combine these method steps in terms of equipment.

### DESCRIPTION OF THE INVENTION

The object is solved by a method which is characterized by the following method steps to be carried out one after the other:
a) setting a temperature of the oil which is suitable for the succeeding method steps as regards the effectiveness of the enzymes and the production of an emulsion;
b) admixing an aqueous pH buffer solution whose pH value is 4 to 5, wherein the quantity of the solution is to be chosen so large that it is sufficient for absorbing the constituents precipitated from the oil in the succeeding method steps;
c) emulsifying the mixture by means of a dispersing tool;
d) holding the emulsion, until a phosphorus concentration of below 30 ppm in the oil phase has been obtained;
e) joint addition of enzymes of the type phospholipase and glucosidase;
f) emulsifying the mixture by means of a dispersing tool;
g) holding the emulsion, until the desired content of phosphorus-containing constituents and steryl glycosides in the oil has been obtained;
h) breaking the emulsion by heating;
i) separating the aqueous phase from the oil by gravity or centrifugation.

Our own experiments surprisingly have shown that enzymes of the type phospholipase or glucosidase can jointly be processed in one method step, i.e. under the same technical conditions in terms of temperature, residence time and shear forces exerted by the dispersing tool, and that the two enzymes do not hinder each other in their effectiveness.

### Preferred Aspects of the Invention

A preferred aspect of the invention is characterized in that the temperature of the treated oil phase in method steps a) to g) lies in the range from 20 to 60° C., preferably in the range from 40 to 50° C. In this temperature range, a high effectiveness of the enzymes does exist. At this temperature it is also possible to produce a particularly fine and stable emulsion.

A further preferred aspect of the invention is characterized in that the pH buffer solution consists of sodium hydroxide and citric acid monohydrate in a molar ratio of 1:1. This buffer solution is particularly suitable, because citric acid and its monohydrate acts as complexing agent for metal ions, such as Fe, Mg and Ca, so that these ions are removed from the oil and pass over into the aqueous phase.

A further preferred aspect of the invention is characterized in that the phospholipase used in method step e) is of the type A₂. This type is particularly suitable, because fatty acid thereby is split off at the C₂ site of the phospholipid. As a result, the phospholipid becomes water-soluble and passes over into the aqueous phase, where it forms a sludge which can be separated from the oil e.g. by means of a centrifuge.

A further preferred aspect of the invention is characterized in that in method steps c) and f) a dispersing device of the type Ultra-Turrax is used. These devices have proven successful for producing an emulsion with small droplet size.

A further preferred aspect of the invention is characterized in that in method steps f) and g) the emulsion has a droplet size of the aqueous phase of 10 to 40 μm. Such an emulsion provides a sufficiently large surface for the reaction of the enzymes and a sufficient stability. Even finer droplets would require too high an influence of shear forces on the mixture, whereby the enzyme might become inactive.

A further preferred aspect of the invention is characterized in that in method step h) a temperature in the range from 65 to 75° C. is set for breaking the emulsion. In this temperature range, breaking the emulsion is possible with sufficient speed. At the same time a damage by oxygen—the reaction does not take place under the exclusion of air—is not yet given at these temperatures.

Further developments, advantages and possible applications of the invention can also be taken from the following description of exemplary embodiments.

All features described form the invention per se or in any combination, independent of their inclusion in the claims or their back-reference.

### EXAMPLES

### Example 1 (Comparative Example)

Water-degummed soybean oil with a phosphorus content of 120 ppm and a steryl glycoside content of 160 ppm was mixed with an aqueous pH buffer solution consisting of sodium hydroxide and citric acid monohydrate in a molar ratio of 1:1. The pH value of the buffer solution was 4.3. The amount of the aqueous pH buffer solution in the mixture was 1.1 wt-%. The temperature of the mixture was adjusted to 45° C. The mixture was dispersed by means of the Ultra-Turrax dispersing device. The mean droplet size of the produced emulsion was 25 μm.

The dispersion was allowed to stand at a constant temperature of 45° C. and the time course of the phosphorus (P) and steryl glycoside (SG) content in the oil phase was measured. For this purpose the emulsion of the sample taken was broken by heating to 70° C., and the aqueous phase and the oil phase were separated by centrifugation. The measurement results are listed in the following table:

| | Elapsed | P content | SG content |
|---|---|---|---|
| | Reaction time [min] | [ppm] | [ppm |
| Addition of pH buffer | 0 | 120*) | 160*) |
| | 60 | 20 | 67 |
| | 120 | 20 | 64 |
| | 180 | 20 | 60 |
| | 240 | 15 | 57 |
| | 300 | 15 | 57 |

*)measured before addition of the pH buffer

The measurement results reveal that the buffer solution alone, due to its citric acid content, already has noticeable effect for lowering the phosphatide and SG content. A part of the phosphatides is rendered hydratable by the citric acid and a part of the steryl glycosides is split into a glucose and a styrene part.

### Example 2 (Invention)

After a dwell time of 30 min, a phospholipase A2 enzyme of the grade Lecitase Novo, PPW 6199 in a dosage of 376 LEU/kg of oil and a glucosidase enzyme of the grade Multifekt GO 5000/L in a dosage of 3 g/kg of oil is added to an emulsion prepared as in Example 1. In the following table, the course of the P and SG content in the oil phase is indicated:

| | Elapsed | P content | SG content |
|---|---|---|---|
| | Reaction time [min] | [ppm] | [ppm |
| Addition of pH buffer | 0 | 120*) | 160*) |
| Addition of enzymes | 30 | | |
| | 60 | 15 | 10 |
| | 120 | 12 | <5 |
| | 180 | 10 | <5 |
| | 240 | 5 | <5 |
| | 300 | 5 | <5 |

*)measured before addition of the pH buffer

The distinctly lower values for the P and SG content, as compared to the Comparative Example, reveal the effect of the jointly added enzymes.

Measurement methods, terms:

determination of the P content according to standard DGF methods, C-III 16a (03)

determination of the SG content according to DIN EN 14 105

LEU, Lecitase Units, Compendium of food additive specifications, Food and Nutrition Paper 52, Addendum 13, page 31, ISBN 92-5-105355-3

1. A method for removing phosphorus-containing constituents and steryl glycosides from crude oil and pre-degummed oil of vegetable or animal origin, comprising the following method steps carried out one after the other:
a) setting a temperature of the oil which is suitable for the succeeding method steps as regards the effectiveness of the enzymes and the production of an emulsion;
b) admixing an aqueous pH buffer solution whose pH value is 4 to 5, wherein the quantity of the solution is to be chosen so large that it is sufficient for absorbing the constituents precipitated from the oil in the succeeding method steps;
c) emulsifying the mixture by means of a dispersing tool;
d) holding the emulsion, until a phosphorus concentration of below 30 ppm in the oil phase has been obtained;
e) joint adding of enzymes of the type phospholipase and glucosidase;
f) emulsifying the mixture by means of a dispersing tool;
g) holding the emulsion, until the desired content of phosphorus-containing constituents and steryl glycosides in the oil has been obtained;
h) breaking the emulsion by heating; and
i) separating the aqueous phase from the oil by gravity or centrifugation.

2. The method according to claim 1, wherein the temperature of the treated oil phase in method steps 1a) to 1g) lies in the range from 20 to 60° C.

3. The method according to claim 1, wherein the pH buffer solution consists of sodium hydroxide and citric acid monohydrate in a molar ratio of 1:1.

4. The method according to claim 1, wherein the phospholipase used in method step 1e) is of the type A₂.

5. The method according to claim 1, wherein in method steps 1f) and 1g) the emulsion has a droplet size of the aqueous phase of 10 to 40 μm.

6. The method according to claim 1, wherein in method step 1h) a temperature in the range from 65 to 75° C. is set for breaking the emulsion.

7. The method according to claim 2, wherein the temperature of the treated oil phase in method steps 1a) to 1g) lies in the range from 40 to 50° C.
